(19) United States
(12) Patent Application Publication
(10) Pub. No.: US 2023/0143821 A1
(43) Pub. Date: May 11, 2023

(54) MACHINING TOOL

(71) Applicant: HONDA MOTOR CO., LTD., Minato-ku, Tokyo (JP)

(72) Inventors: Tadatomo Hatayama, Haga-gun, Tochigi-ken (JP); Masaya Koide, Haga-gun, Tochigi-ken (JP); Toshihiko Fukuda, Haga-gun, Tochigi-ken (JP); Hideki Oka, Minato-ku, Tokyo (JP)

(21) Appl. No.: 17/908,548

(22) PCT Filed: Mar. 4, 2021
(86) PCT No.: PCT/JP2021/008330

§ 371 Date: Sep. 1, 2022

(30) Foreign Application Priority Data
Mar. 4, 2020 (JP) 2020-036408

(51) Int. Cl. B23B 29/034; B23B 41/12; B23B 51/08

(52) U.S. Cl. CPC B23B 29/034; B23B 41/12; B23B 51/08

(57) ABSTRACT

In a tool holding portion of a machining tool, a cartridge is provided so as to be movable forward and backward. A cam accommodated inside a cam accommodation portion rotates while the cam is in abutment against the cartridge to thereby move the cartridge forward and backward. A rod which moves forward and backward inside a tool body along an axis is provided with an abutment portion. The abutment portion abuts against an abutment position of the cam according to the forward and backward movement of the rod to thereby rotate the cam. A restriction mechanism is capable of adjusting the phase of the cam when the abutment portion is apart from the abutment position so that a reference position is reached where the abutment position faces the abutment portion.

### TECHNICAL FIELD

The present invention relates to a machining tool that cuts an inner periphery of an opening of a workpiece to form a plurality of machined surfaces.

### BACKGROUND ART

As an example, WO 2020/017644 A1 discloses a machining tool that cuts an inner periphery of an opening of a workpiece to form a plurality of machined surfaces. With this type of machining tool, cutting is performed by bringing a plurality of cutting tools into contact with machining target portions of the workpiece at different timings. In this way, a cutting tool forming a machined surface required to be formed with higher precision than machined surfaces with large machining allowances is prevented from becoming more prone to wear than the other cutting tools, for example.

Specifically, the machining tool includes a tool body that is rotatable about an axial line. On the tip side of the tool body, a fixed cutting tool is fixed, and a cartridge is provided so as to be movable along this axial line. A movable cutting tool is attached to this cartridge. Furthermore, the cartridge can move by having a cam, which is provided inside the tool body, abut against the cartridge to rotate. The cam can rotate by having an abutment portion of a rod, which moves back and forth along the axial line inside the tool body, abut against an abutment position of the cam in response to the back and forth movement of the rod.

When using the machining tool to cut a machining target portion of the workpiece, the fixed cutting tool is brought into contact with the machining target portion while the tool body is rotationally driven. At this time, the relative position of the cartridge with respect to the tool body is adjusted such that the movable cutting tool is distanced from the machining target portion. By performing the cutting in this manner, a prescribed machined surface, among a plurality of machined surfaces, is formed at the machining target portion. Next, by adjusting the relative position of the cartridge with respect to the tool body, the movable cutting tool, instead of the fixed cutting tool, is brought into contact with the machining target portion to perform cutting. In this way, the remaining machined surfaces are formed at the machining target portion.

### SUMMARY OF THE INVENTION

In the machining tool described above, the tool body is formed from: a cutting tool holding portion, which is arranged at the tip side of the machining tool and holds a cutting tool; and a cam housing portion, which is fixed in an attachable/detachable manner to a base side of the cutting tool holding portion and houses the cam therein. Due to this, it is possible to detach the cutting tool holding portion from the cam housing portion and replace a worn-down cutting tool held by the cutting tool holding portion, for example.

With this machining tool, when attaching or detaching the cam housing portion and the cutting tool holding portion to or from each other or when adjusting the position of the cutting tool relative to the cutting tool holding portion, for example, there are cases where the abutment portion of the rod is distanced from the abutment position of the cam. In such a case, since the cam is rotatable, the abutment position of the cam might become skewed from an orientation facing the abutment portion. When the abutment portion of the rod is again brought near the cam in this state, there is a concern that the abutment portion will abut against a location other than the abutment position of the cam. When the abutment portion abuts against a location other than the abutment position, the load placed on the cam and the rod is increased, and therefore such a situation is preferably avoided.

The present invention has been devised in relation to this type of technology, and has the object of providing a machining tool that can avoid a situation where an abutment portion of a rod abuts against a location other than an abutment position of a cam.

A first aspect of the present invention is a machining tool that cuts an inner periphery of a workpiece including an opening to form a plurality of machined surfaces, the machining tool including: a tool body that includes a cam housing portion and a cutting tool holding portion fixed in an attachable/detachable manner to a tip side of the cam housing portion, and is rotationally driven around an axial line; a plurality of cutting tools held by the cutting tool holding portion and configured to rotate along with the tool body; a cartridge which is provided to the cutting tool holding portion in a manner to be movable back and forth, and to which at least one of the plurality of cutting tools is attached; a cam housed inside the cam housing portion and configured to move the cartridge back and forth by abutting against the cartridge and rotating; a rod configured to move back and forth along the axial line inside the tool body; an abutment portion provided on the rod and configured to cause the cam to rotate by abutting against an abutment position of the cam according to back and forth movement of the rod; and a restricting mechanism configured to adjust a phase of the cam in a state where the abutment portion is separated from the abutment position, in a manner so that the phase of the cam becomes a reference position where the abutment position faces the abutment portion.

This machining tool includes the restricting mechanism that is capable of adjusting the phase of the cam such that the phase of the cam becomes the reference position where the abutment position of the cam separated from the abutment portion of the rod faces the abutment portion. Therefore, it is possible to avoid a situation where the abutment portion of the rod abuts against a location other than the abutment position of the cam.

### BRIEF DESCRIPTION OF DRAWINGS

FIG. 1 is a schematic explanatory diagram of a tip surface of a machining tool according to an embodiment of the present invention;

FIG. 2 is cross-sectional view of main portions taken along the line II-II in FIG. 1 in a state where a cartridge is moved backward;

FIG. 3 is a cross-sectional view of main portions in a state where the cartridge of the machining tool of FIG. 2 is moved forward;

FIG. 4 is a cross-sectional view of main portions for describing a state where a rod of the machining tool of FIG. 2 is moved backward and a cutting tool holding portion and a cam housing portion are separated;

FIG. 5A is an enlarged cross-sectional side view of main portions of the machining tool for describing a restricting mechanism when a cam is at a reference position;

FIG. 5B is a cross-sectional view taken along the line VB-VB of FIG. 5A;

FIG. 6A is an enlarged cross-sectional side view of main portions of the machining tool for describing the restricting mechanism when the cam is not at the reference position;

FIG. 6B is a cross-sectional view taken along the line VIB-VIB of FIG. 6A;

FIG. 7 is a schematic partial cross-sectional view of a valve seat material and a cylinder head body before cutting;

FIG. 8 is a schematic partial dross-sectional view of a cylinder head after cutting of the valve seat material of FIG. 7;

FIG. 9 is a schematic explanatory diagram for describing a state of machining a relief surface in the valve seat material of FIG. 7 using a first cutting tool and a second cutting tool;

FIG. 10 is a schematic explanatory diagram for describing a state of machining a valve seat surface in the valve seat material of FIG. 9 using a third cutting tool;

FIG. 11 is a cross-sectional view of main portions orthogonal to an axial line of the machining tool for describing a restricting mechanism according to a modification;

FIG. 12A is an enlarged cross-sectional side view of main portions of the machining tool for describing the restricting mechanism of FIG. 11 when the cam is at the reference position; and

FIG. 12B is an enlarged cross-sectional side view of main portions of the machining tool for describing the restricting mechanism of FIG. 11 when the cam is not at the reference position.

### DESCRIPTION OF THE INVENTION

Preferred embodiments of a machining tool according to the present invention will be presented and described below with reference to the accompanying drawings. In the drawings below, constituent components that have the same or similar functions and effects may be given the same reference numerals, and redundant descriptions thereof may be omitted.

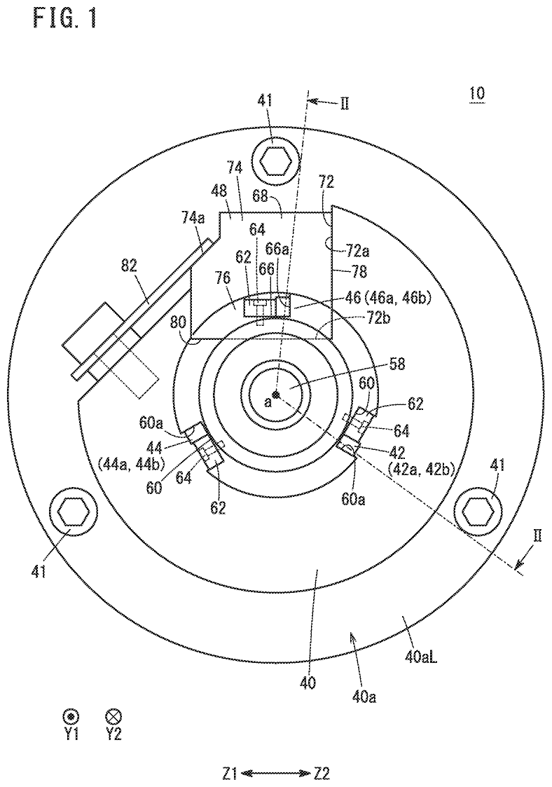

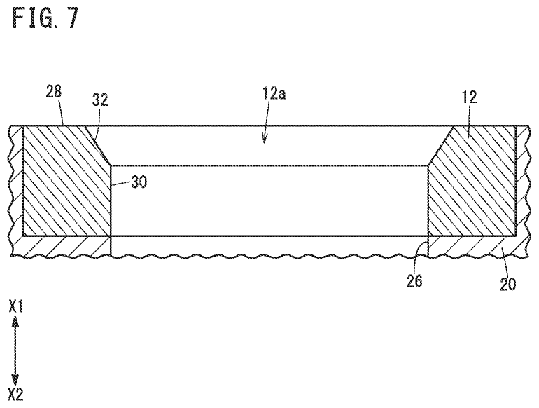

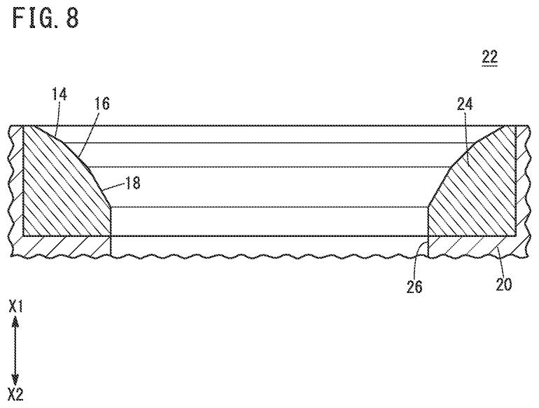

The following describes an example in which a machining tool 10 according to the present embodiment shown in FIGS. 1 to 6B is applied, and a valve seat material 12 shown in FIG. 7 is used as a workpiece, to cut an inner periphery of an opening 12a of the valve seat material 12, thereby forming a first relief surface 14, a valve seat surface 16, and a second relief surface 18 shown in FIG. 8 as a plurality of machined surfaces. The first relief surface 14, the valve seat surface 16, and the second relief surface 18 are inclined surfaces having different inclination angles from each other relative to an axial direction of the opening 12a. As shown in FIG. 7, the valve seat material 12 is press-fitted or joined to a cylinder head body 20, and a valve seat 24 of a cylinder head 22 shown in FIG. 8 is formed by performing the cutting as described above.

However, the target on which cutting can be performed by applying the machining tool 10 is not limited to the valve seat material 12. Furthermore, the plurality of machined surfaces that can be formed by the machining tool 10 are not limited to the first relief surface 14, the valve seat surface 16, and the second relief surface 18 described above. The machining tool 10 can be favorably applied in a case where cutting is performed on the inner periphery of an opening of a workpiece to form a plurality of machined surfaces. Examples of such a case include a case where a machined surface formed by rough boring and a machined surface formed by fine boring are each formed in an inner periphery of an opening of a workpiece, a case where a machined surface formed by boring and a machined surface formed by chamfering are each formed in the inner periphery of the opening of the workpiece, and the like.

First, a simple description of the cylinder head 22 is provided, while referencing FIG. 8. As an example, the cylinder head 22 includes the annular valve seat 24, which is made of a sintered body of an iron-based material such as steel, and the cylinder head body 20, which is made of an aluminum-based material such as pure aluminum or an aluminum alloy. The valve seat 24 may further include a material with high electrical conductivity such as a copper-based material.

A port 26 is formed in the cylinder head body 20. The port 26 opens toward a combustion chamber (not shown). In the present embodiment, the annular valve seat 24 is inserted into an opening edge portion on the combustion chamber side of the port 26, thereby fitting the valve seat 24 into this opening edge portion.

On the inner periphery of the valve seat 24, the first relief surface 14, the valve seat surface 16, and the second relief surface 18 having different surface directions from each other are arranged in the stated order from one end side (arrow X1 side) to the other end side (arrow X2 side) in the axial direction of the valve seat 24. The first relief surface 14, the valve seat surface 16, and the second relief surface 18 are each inclined in a direction in which the diameter of the opening is widened toward the combustion chamber side (arrow X1 side). As an example of the inclination angle that each of these surfaces forms with respect to the axial direction of the valve seat 24, the first relief surface 14 forms an angle of 60°, the valve seat surface 16 forms an angle of 45°, and the second relief surface 18 forms an angle of 30°, but these angles are not particularly limited.

The port 26 can be opened and closed by seating or separating a valve (not shown) on or from the valve seat surface 16, among the inner peripheral surfaces of the valve seat 24. Therefore, in order for the valve and the valve seat surface 16 to contact each other without a gap to make the cylinder head 22 high-quality, it is necessary to perform high-precision machining particularly on the valve seat surface 16 among the inner peripheral surfaces of the valve seat 24, with regard to the roundness, surface roughness, and the like.

Next, a description is provided of the valve seat material 12 before the cutting is performed to form the valve seat 24, in other words, the valve seat material 12 in which the first relief surface 14, the valve seat surface 16, and the second relief surface 18 are not yet formed, while referencing FIG. 7. The valve seat material 12 has an annular shape and is press-fitted into the cylinder head body 20. The inner periphery of the valve seat material 12 has, for example, an orthogonal end surface 28 arranged at one end side (arrow X1 side) in the axial direction, an axial surface 30 arranged at the other end side in the axial direction, and a tapered surface 32 arranged between the orthogonal end surface 28 and the axial surface 30. The orthogonal end surface 28 is orthogonal to the axial direction. The axial surface 30 is formed flush with the inner peripheral surface of the port 26. The tapered surface 32 has a tapered shape inclined in a direction in which the diameter of the opening is widened toward the one end side (arrow X1 side) in the axial direction.

Next, a description is provided of the machining tool 10, while referencing FIGS. 1 to 6B. The machining tool 10 cuts the inner periphery of the opening 12a of the valve seat material 12 shown in FIG. 7, to form the first relief surface 14, the valve seat surface 16, and the second relief surface 18 shown in FIG. 8. In the present embodiment, the machining tool 10 is a composite machining tool capable of both cutting the valve seat material 12 and reaming a valve guide hole (not shown). The valve guide hole is provided in the cylinder head body 20, and allows a shaft portion (not shown) of the valve to be inserted therethrough.

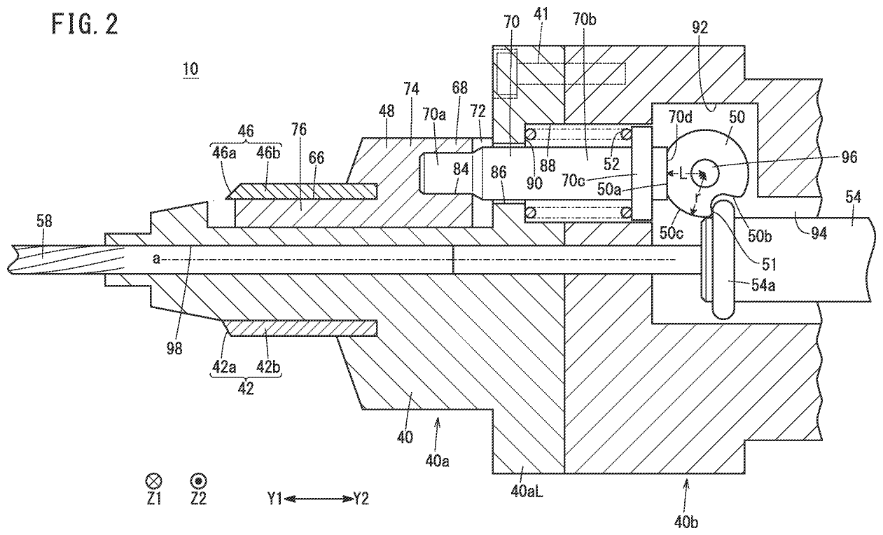

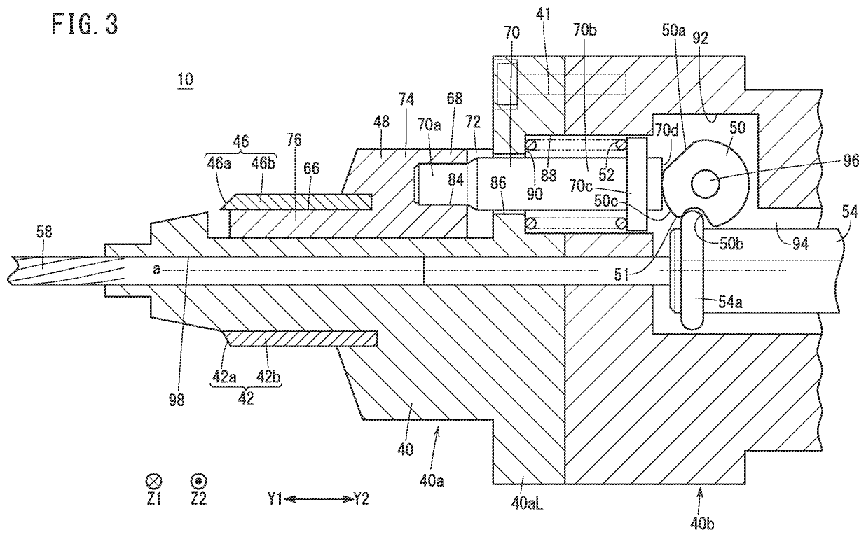

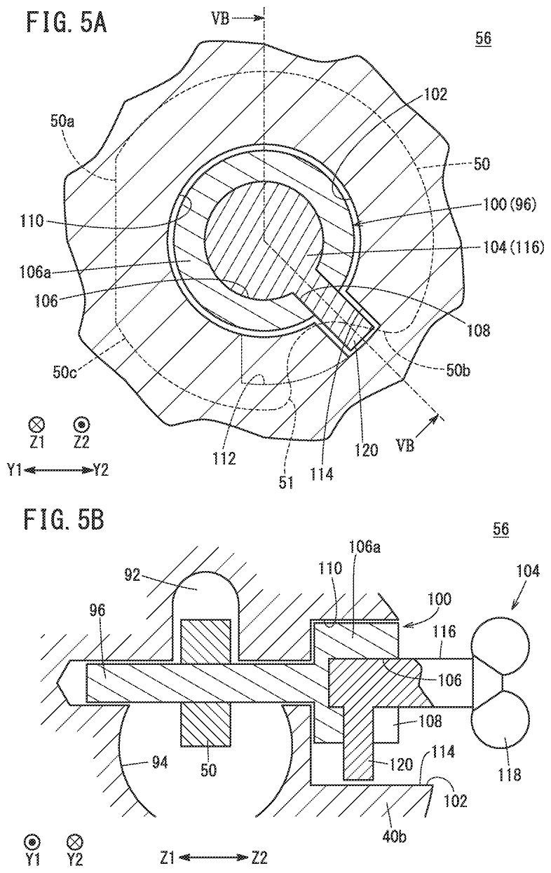

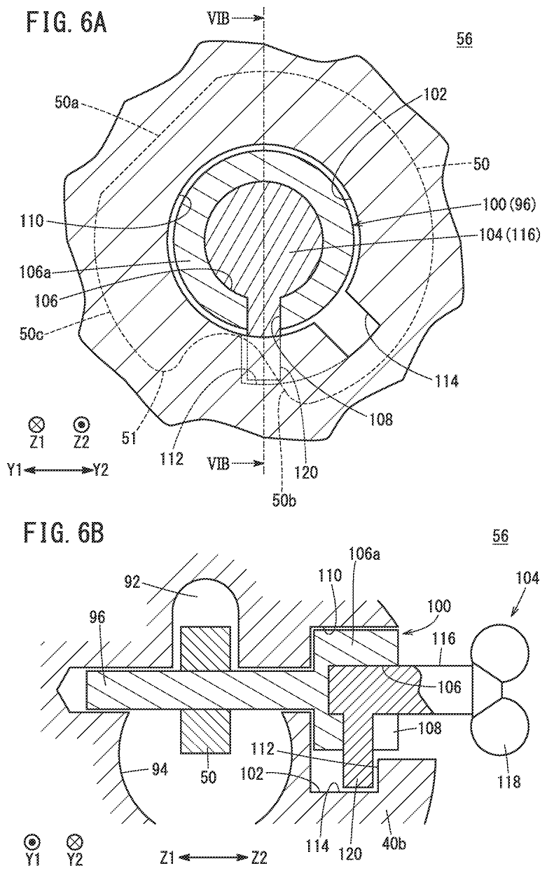

Specifically, as shown in FIGS. 2 and 3, the machining tool 10 includes a tool body 40, a first cutting tool 42, a second cutting tool 44 (FIG. 1), a third cutting tool 46, a cartridge 48, a cam 50, a cartridge biasing member 52, a rod 54, a restricting mechanism 56 shown in FIGS. 5A to 6B, and a reamer 58.

As shown in FIGS. 2 and 3, the tool body 40 is formed by a cutting tool holding portion 40a and a cam housing portion 40b, which are fixed to each other in an attachable/detachable manner. The cutting tool holding portion 40a and the cam housing portion 40b are arranged in the stated order from the tip side (arrow Y1 side) to the base side (arrow Y2 side) of the tool body 40. The cutting tool holding portion 40a has a substantially cylindrical shape with steps causing the diameter at the tip side to become less than the diameter at the base side. Furthermore, a large-diameter portion 40aL is provided at the base side of the cutting tool holding portion 40a. The base side of the cutting tool holding portion 40a and the tip side of the cam housing portion 40b are fixed in an attachable/detachable manner by, for example, bolting a bolt 41 to the outer peripheral side of this large-diameter portion 40aL.

The base side of the cam housing portion 40b is fixed to a rotating spindle of a rotating drive mechanism included in a machine tool (not shown), for example. Due to this, the tool body 40 is rotationally driven about an axial line “a”. Furthermore, the tool body 40 is driven back and forth along the axial line “a” by a tool body drive mechanism included in the machine tool.

The first cutting tool 42 has a cutting edge 42a for machining the first relief surface 14 (FIG. 8), and is mounted in an attachable/detachable manner to the cutting tool holding portion 40a of the tool body 40 via a shank 42b. Specifically, as shown in FIG. 1, by gripping the shank 42b between an inner wall 60a of a housing groove 60 provided along the axial line “a” in the cutting tool holding portion 40a and a tightening member 62 provided in front of the inner wall 60a in the housing groove 60 in the rotational direction of the cutting tool holding portion 40a, the first cutting tool 42 is directly fixed to the cutting tool holding portion 40a.

By screwing together a screw 64 and a screw hole provided extending in the radial direction of the cutting tool holding portion 40a, the tightening member 62 presses the shank 42b from the front in the rotational direction of the cutting tool holding portion 40a toward the inner wall 60a of the housing groove 60, thereby making it possible to apply a tightening force. Furthermore, by loosening the engagement between the screw hole and the screw 64 with the tightening member 62, it is possible to relax the grip on the shank 42b, thereby making it possible to remove and insert the shank 42b between the inner wall 60a of the housing groove 60 and the tightening member 62.

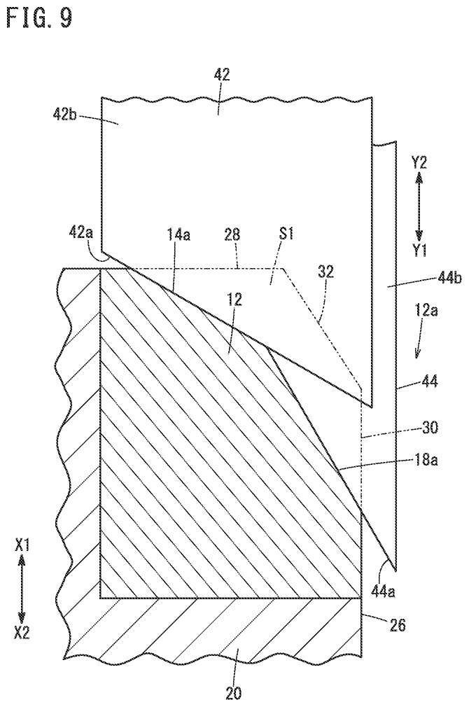

The second cutting tool 44 has a cutting edge 44a (see FIG. 9) for machining the second relief surface 18 (see FIG. 8), and is mounted in an attachable/detachable manner to the cutting tool holding portion 40a via a shank 44b. In the same manner as the first cutting tool 42, the second cutting tool 44 is directly fixed to the cutting tool holding portion 40a via the tightening member 62.

The third cutting tool 46 has a cutting edge 46a for machining the valve seat surface 16 (see FIG. 8), and is mounted in an attachable/detachable manner to the cartridge 48 via a shank 46b. Specifically, by gripping the shank 46b between an inner wall 66a of a housing groove 66 provided along the axial line “a” in the cartridge 48 and the tightening member 62 provided in front of the inner wall 66a in the rotational direction, the third cutting tool 46 is fixed to the cartridge 48.

The cartridge 48 is mounted to the cutting tool holding portion 40a in a manner to be movable back and forth along the axial line “a”, and is rotationally driven together with the cutting tool holding portion 40a. Below, a direction toward the tip of the tool body 40 (arrow Y1 side) is the forward direction of the cartridge 48, and a direction toward the base of the tool body 40 (arrow Y2 side) is the backward direction of the cartridge 48.

As shown in FIGS. 2 and 3, the cartridge 48 is formed by integrating a cartridge body 68 and a push rod 70. The cartridge body 68 is arranged to be slidable inside a groove 72 formed along the axial line “a” in the cutting tool holding portion 40a. Furthermore, the cartridge body 68 includes a body 74 and a extending portion 76 that extends from a portion of the body 74 on the axial line “a” side (the center side of the cutting tool holding portion 40a in the radial direction) toward the tip side (arrow Y1 side). The housing groove 66, which houses the shank 46b of the third cutting tool 46, is provided in the entire extending portion 76 along the axial direction and in a portion of the body 74 on the tip side.

As shown in FIG. 1, when viewed from the tip side of the axial line “a”, the body 74 has a substantially rectangular shape, and a corner portion thereof that is on the front side in the rotational direction and on the outer side in the radial direction of the cutting tool holding portion 40a is cut away to provide a pressure receiving surface 74a. In the body 74 and the extending portion 76, end surfaces 78 on the backward side in the rotational direction are formed flush with each other, and end surfaces 80 on the axial line “a” side are formed flush with each other. These end surfaces 78 and 80 are orthogonal to each other. The pressure receiving surface 74a is inclined relative to both the end surfaces 78 and 80.

Inside the groove 72, a first inner wall surface 72a of the groove 72 abuts against the end surface 78 of the cartridge body 68, and a second inner wall surface 72b of the groove 72 abuts against the end surface 80. The first inner wall surface 72a extends along the end surface 78 and the second inner wall surface 72b extends along the end surface 80, and therefore the first inner wall surface 72a and the second inner wall surface 72b are orthogonal to each other.

A leaf spring 82, which is mounted on the cutting tool holding portion 40a by bolting or the like, abuts against the pressure receiving surface 74a from the front in the rotational direction. Due to this leaf spring 82, the cartridge body 68 is pressed in a direction inclined relative to both the first inner wall surface 72a and the second inner wall surface 72b of the groove 72, from the front in the rotational direction of the cartridge body 68.

As shown in FIGS. 2 and 3, a fitting hole 84 is provided along the axial line “a” at the base side of the body 74, and a small-diameter portion 70a at the tip side of the push rod 70 is fitted into this fitting hole 84. A shaft portion 70b, which has a larger diameter than the small-diameter portion 70a, is provided at the base side of the small-diameter portion 70a of the push rod 70, and a flange portion 70c is provided at the base side of the shaft portion 70b. A through-hole 86 is provided along the axial line “a” in a part of the large-diameter portion 40aL of the cutting tool holding portion 40a facing the groove 72. By inserting the shaft portion 70b of the push rod 70 through this through-hole 86 in a manner to be movable back and forth, the majority of the push rod 70, excluding the tip side thereof, is inserted into a push rod chamber 88 formed by the cutting tool holding portion 40a and the cam housing portion 40b.

The inner diameter of the through-hole 86 is slightly greater than the outer diameter of the shaft portion 70b of the push rod 70, and less than the inner diameter of the push rod chamber 88. Therefore, a stepped surface 90 is formed between the push rod chamber 88 and the through-hole 86.

The flange portion 70c of the push rod 70 has a diameter that is slightly smaller than the inner diameter of the push rod chamber 88, and can slide inside the push rod chamber 88. The cartridge biasing member 52, which is made of an elastic body such as a spring, for example, is provided between the flange portion 70c and the stepped surface 90. The cartridge biasing member 52 provides an elastic bias in a direction causing the flange portion 70c and the stepped surface 90 to move away from each other, in other words, a direction causing the cartridge 48 to move backward.

The cam housing portion 40b is provided with: a cam chamber 92 in communication with the base side of the push rod chamber 88; and a rod chamber 94 in communication with the axial line “a” side of the cam chamber 92 (the center side of the cam housing portion 40b in the radial direction). The cam 50, which abuts against a base surface 70d of the push rod 70 (base surface of the cartridge 48), is provided in the cam chamber 92 in a manner to be rotatable via a cam shaft 96.

The cam 50 abuts against the base surface 70d of the push rod 70 to move the cartridge 48 back and forth. Specifically, the cam 50 has a substantially circular shape and includes a cutout surface 50a obtained by cutting away a portion of an arc, a recessed portion 50b that is depressed toward the center of the circle, and an arc-shaped surface 50c provided between the cutout surface 50a and the recessed portion 50b. An abutment portion 54a of the rod 54 can be inserted into the recessed portion 50b. The abutment portion 54a protrudes with an annular shape from the outer peripheral surface of the rod 54 provided to be movable back and forth along the axial line “a” inside the rod chamber 94. An abutment position 51, which can abut against the abutment portion 54a inserted into the recessed portion 50b, is provided on the inner surface of the recessed portion 50b.

By moving the rod 54 back and forth while inserting the abutment portion 54a into the recessed portion 50b, the cam 50 is rotationally driven with the center of the circle (arc) as the rotational center. Specifically, the direction of the rotational axis of the cam 50 passing through the rotational center described above intersects the axial line “a”, and is preferably orthogonal to the axial line “a”. Furthermore, by moving the rod 54 forward while bringing the abutment portion 54a into abutment against the abutment position 51, the cam 50 rotates such that the arc-shaped surface 50c abuts against the base surface 70d of the cartridge 48 (push rod 70), as shown in FIG. 3.

On the other hand, by moving the rod 54 backward while bringing the abutment portion 54a into abutment against the abutment position 51, the cam 50 rotates such that the cutout surface 50a abuts against the base surface 70d of the cartridge 48, as shown in FIG. 2. In this way, it is possible to selectively bring the arc-shaped surface 50c and the cutout surface 50a into abutment against the base surface 70d of the cartridge 48.

A radius r of the arc-shaped surface 50c is greater than a length L of a perpendicular line from the center of the circle to the cutout surface 50a. Therefore, as shown in FIG. 3, by bringing the arc-shaped surface 50c into abutment against the base surface 70d, it is possible for the cartridge 48 to move forward against the elastic force of the cartridge biasing member 52 by an amount corresponding to a difference between the radius r and the length L of the perpendicular line, compared to a case where the cutout surface 50a abuts against the base surface 70d. In this way, in a state where the cartridge 48 has moved forward, the cutting edge 46a of the third cutting tool 46 is arranged on the farther toward the tip side of the tool body 40 than the cutting edges 42a and 44a of the first cutting tool 42 and the second cutting tool 44, for example. As a result, it is possible to perform cutting with only the third cutting tool 46 contacting the inner periphery of the valve seat material 12.

On the other hand, as shown in FIG. 2, by bringing the cutout surface 50a into abutment against the base surface 70d of the cartridge 48, it is possible for the cartridge 48 to move backward under the effect of the elastic bias of the cartridge biasing member 52 by an amount corresponding to a difference between the radius r and the length L of the perpendicular line, compared to a case where the arc-shaped surface 50c abuts against the base surface 70d. In this way, in a state where the cartridge 48 has moved backward, the cutting edges 42a and 44a of the first cutting tool 42 and the second cutting tool 44 are arranged farther toward the tip side of the tool body 40 than the cutting edge 46a of the third cutting tool 46, for example. As a result, it is possible to perform cutting with only the first cutting tool 42 and the second cutting tool 44 contacting the inner periphery of the valve seat material 12.

The rod 54 can be moved back and forth along the axial line “a” by an actuator (not shown) provided on the base side of the rod 54. The actuator includes fluid pressure actuators such as hydraulic cylinders. Furthermore, an internal rod flow path (not shown) for supplying coolant to the tip side of the tool body 40 is provided along the axial line “a” inside the rod 54.

A reamer hole 98, through which the reamer 58 fixed in an attachable/detachable manner to the tip side of the rod 54 is inserted, is in communication with the tool body 40 farther on the tip side than the rod chamber 94. The reamer 58 can move back and forth inside the reamer hole 98 in accordance with the back and forth movement of the rod 54, and protrudes from the tip of the cutting tool holding portion 40a.

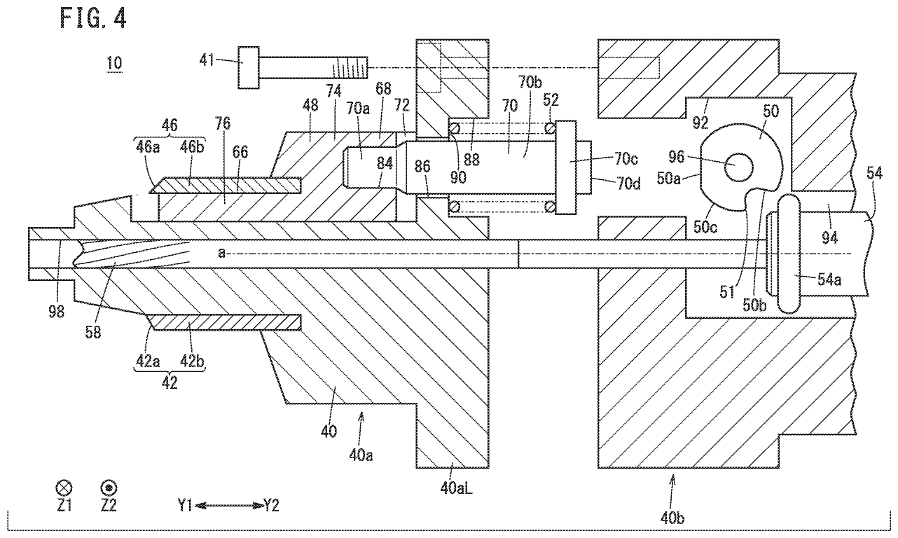

With this machining tool 10, as shown in FIG. 4, by releasing the bolting caused by the bolt 41, the tool body 40 can be separated into the cutting tool holding portion 40a and the cam housing portion 40b. In this case, the push rod chamber 88 is separated into a portion formed in the cutting tool holding portion 40a and a portion formed in the cam housing portion 40b. Furthermore, the push rod 70 and the cartridge biasing member 52 fixed to the cutting tool holding portion 40a are removed from the portion of the push rod chamber 88 formed in the cam housing portion 40b, and are separated from the cam housing portion 40b.

The restricting mechanism 56 of FIGS. 5A to 6B is configured in a manner to be capable of adjusting the phase of the cam 50 to a reference position, in a state where the rod 54 moves backward and the abutment portion 54a of the rod 54 is separated from the abutment position 51 of the cam 50. The reference position is where the abutment position 51 of the cam 50 faces the abutment portion 54a of the rod 54 that has moved back, and in the present embodiment is where the opening side of the recessed portion 50b of the cam 50 faces the abutment portion 54a of the rod 54 that has moved back. It should be noted that, as shown in FIG. 2, the cam 50 is at the reference position when the cutout surface 50a of the cam 50 abuts against the base surface 70d of the push rod 70.

Specifically, as shown in FIGS. 5A to 6B, the restricting mechanism 56 is formed from the cam shaft 96, an engaging portion 100, an insertion hole 102, and an insertion member 104. The cam shaft 96 extends along the direction of the rotational axis of the cam 50 (arrow Z1 and arrow Z2 directions), and is fixed to the cam 50 in a manner to be rotatable along with the cam 50. One end portion of the cam shaft 96 in the extension direction (end portion on the arrow Z1 side) is rotatably fixed to the inner wall of the cam chamber 92. The other end portion of the cam shaft 96 in the extension direction (end portion on the arrow Z2 side) is provided with the engaging portion 100. The engaging portion 100 includes a concave portion 106, which is depressed from the other end portion toward the one end portion of the cam shaft 96, and an insertion groove 108, which is formed by cutting away, in the radial direction of the cam shaft 96, a portion of a peripheral wall 106a forming the concave portion 106.

The insertion hole 102 is formed in a wall portion of the cam housing portion 40b (FIGS. 5B and 6B), and enables communication between the engaging portion 100 and the outside of the cam housing portion 40b. Furthermore, the insertion hole 102 enables the extraction of the insertion member 104 inserted through the insertion hole 102, only when the cam 50 is at the reference position. Specifically, the insertion hole 102 includes an axial hole 110, a circumferential groove 112 (FIGS. 5A and 6A), and a keyhole portion 114. The axial hole 110 extends along the direction of the rotational axis of the cam 50. The circumferential groove 112 extends in a direction intersecting the axial hole 110, inside the wall portion of the cam housing portion 40b. The keyhole portion 114 enables communication, in the direction of the rotational axis of the cam 50, between only a portion of the circumferential groove 112 and the outside of the cam housing portion 40b.

The insertion member 104 can rotate along with the cam 50, by being inserted through the insertion hole 102 from outside the cam housing portion 40b to engage with the engaging portion 100. Specifically, the insertion member 104 has a shaft portion 116, a gripping portion 118 (FIGS. 5B and 6B), and a restricting portion 120.

One end side of the shaft portion 116 in the axial direction engages with the engaging portion 100 by being inserted into the concave portion 106 through the axial hole 110. The gripping portion 118 is provided at the other end side of the shaft portion 116 in the axial direction, and can be gripped by an operator when the operator inserts the insertion member 104 through the insertion hole 102 or rotates the insertion member 104.

The restricting portion 120 is a protruding piece that protrudes from the shaft portion 116 in the radial direction of the shaft portion 116. When inserting the shaft portion 116 through the axial hole 110, the restricting portion 120 is inserted into the keyhole portion 114. Furthermore, when inserting the shaft portion 116 into the concave portion 106, the restricting portion 120 is inserted into the insertion groove 108 of the engaging portion 100.

In other words, as shown in FIGS. 5A and 5B, when the keyhole portion 114 and the insertion groove 108 overlap according to the phase of the cam shaft 96 relative to the insertion hole 102, the shaft portion 116 can be inserted through the axial hole 110 to engage with the engaging portion 100, while the restricting portion 120 is inserted into the keyhole portion 114 and the insertion groove 108. The positional relationship among the keyhole portion 114, the insertion groove 108, and the recessed portion 50b (abutment position 51) of the cam 50 is set such that the cam 50 is at the reference position when the keyhole portion 114 and the insertion groove 108 overlap in this manner.

By causing the restricting portion 120 inserted into the insertion groove 108 to abut against the inner wall of the insertion groove 108, the rotational force of the insertion member 104 can be transmitted to the cam shaft 96. Therefore, as an example, by gripping the gripping portion 118 and rotating the insertion member 104 in a state where the shaft portion 116 is engaged with the engaging portion 100, it is possible to rotate the cam 50 via the restricting portion 120 and the cam shaft 96. When rotating the insertion member 104 in this manner, the restricting portion 120 can move inside the circumferential groove 112 in accordance with the rotation of the cam 50, as shown in FIGS. 6A and 6B.

The restricting portion 120 inside the circumferential groove 112 can move to the outside of the cam housing portion 40b from the circumferential groove 112 only through the keyhole portion 114. Therefore, as shown in FIGS. 5A and 5B, the insertion member 104 can be extracted from the insertion hole 102 only when the restricting portion 120 in the insertion groove 108 is at a position where it overlaps the keyhole portion 114, that is, only when the cam 50 is at the reference position. In other words, as shown in FIGS. 6A and 6B, the insertion member 104 is restricted from being extracted from the insertion hole 102 when the restricting portion 120 in the insertion groove 108 is not at a position where it overlaps the keyhole portion 114, that is, when the cam 50 is not at the reference position.

The following describes the main operation of the machining tool 10. As shown in FIG. 2, by moving the rod 54 backward under the effect of the actuator described above, the cutout surface 50a of the cam 50 is brought into abutment against the base surface 70d of the cartridge 48. Due to this, the cartridge 48 moves backward, and therefore the cutting edges 42a and 44a of the first cutting tool 42 and second cutting tool 44 attached directly to the tool body 40 can be moved farther forward than the cutting edge 46a of the third cutting tool 46 attached to the cartridge 48.

In this state, while rotationally driving the tool body 40, the tool body 40 is inserted into the opening 12a of the valve seat material 12 of FIG. 7 from the one end side toward the other end side in the axial direction. Due to this, first, reaming of the valve guide hole is performed by the reamer 58 provided on the tip of the tool body 40.

Next, as shown in FIG. 9, the respective cutting edges 42a and 44a of the first cutting tool 42 and second cutting tool 44 are brought into contact with the valve seat material 12, and cutting is performed to form the first relief surface 14 and the second relief surface 18 shown in FIG. 8. In this cutting, the valve seat material 12 is cut from the orthogonal end surface 28 side and the tapered surface 32 side by the first cutting tool 42 and the second cutting tool 44.

After the cutting has been performed to a point where a portion of the valve seat material 12 corresponding to a machining allowance S1 shown by the two-dot chain line in FIG. 9 has been cut away, the tool body 40 is moved backward slightly toward the one end side (arrow X1 side) in the axial direction, thereby separating the valve seat material 12 from the first cutting tool 42 and the second cutting tool 44. As a result, a first cut surface 14a with the same inclination angle as the first relief surface 14, and a second cut surface 18a with the same inclination angle as the second relief surface 18, are formed in the valve seat material 12.

Next, by moving the rod 54 forward under the effect of the actuator described above, the arc-shaped surface 50c of the cam 50 is brought into abutment against the base surface 70d of the push rod 70. Due to this, the cartridge 48 moves backward, and therefore the cutting edge 46a of the third cutting tool 46 attached to the cartridge 48 can be moved farther forward than the cutting edges 42a and 44a of the first cutting tool 42 and the second cutting tool 44 directly attached to the tool body 40.

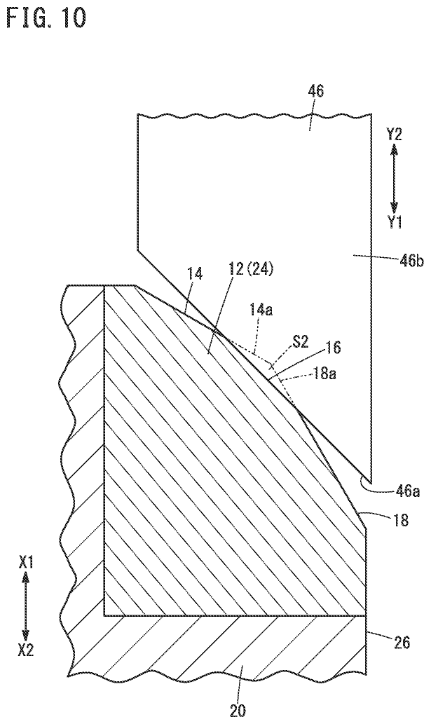

In this state, while rotationally driving the tool body 40, the tool body 40 is moved forward toward the other end side (arrow X2 side) in the axial direction, and as shown in FIG. 10, the cutting edge 46a of the third cutting tool 46 is brought into contact with the valve seat material 12 from which the machining allowance S1 has been removed, and cutting is performed to form the valve seat surface 16 between the first cut surface 14a and the second cut surface 18a. After the cutting has been performed to a point where a portion of the valve seat material 12 corresponding to a machining allowance S2 shown by the two-dot chain line in FIG. 10 has been cut away, the tool body 40 is moved backward toward the one end side in the axial direction. As a result, the valve seat 24 is obtained, in which the first relief surface 14, the valve seat surface 16, and the second relief surface 18 are formed in the stated order from the one end side in the axial direction in the inner periphery of the opening.

Due to the cutting performed as described above, wear of the first cutting tool 42, the second cutting tool 44, and the third cutting tool 46 (also referred to below collectively as “cutting tools”) might occur. In such a case, as an example, the machining tool 10 is removed from a machining center (not shown) while the cutting tool holding portion 40a and the cam housing portion 40b remained fixed, and replacement or the like of the worn cutting tool is performed.

In the machining tool 10, as described above, the cutting tool holding portion 40a and the cam housing portion 40b are fixed in an attachable/detachable manner. Therefore, in a state where the cutting tool holding portion 40a holding the cutting tool has been removed from the cam housing portion 40b, replacement or the like of the worn cutting tool may be performed.

In order to perform the machining of the first relief surface 14, the valve seat surface 16, and the second relief surface 18 with high precision by the machining tool 10, it is necessary for the fixed positions of the cutting edges 42a, 44a, and 46a of the cutting tools relative to the cutting tool holding portion 40a to be set with high precision. Therefore, in particular, after a cutting tool has been replaced in the manner described above, it is preferable to perform an adjustment of the fixed positions of the cutting edges 42a, 44a, and 46a of the cutting tools relative to the cutting tool holding portion 40a (also referred to below simply as a “fixed position adjustment”) using a tool setter (not shown) or the like, for example.

The following describes a method for performing the fixed position adjustment in a state where the cutting tool holding portion 40a is attached to the cam housing portion 40b. When performing the fixed position adjustment, a state is brought about in which the rod 54 is moved backward such that the abutment portion 54a is separated from the abutment position 51 of the cam 50. Due to this, the cam 50 is not in contact with the abutment portion 54a of the rod 54. In other words, the cam 50 is released from a state of having its rotation restricted by the contact with the abutment portion 54a. In the present embodiment, the state where the rod 54 has been moved backward is realized by removing the machining tool 10 from the machining center (not shown).

Before or after the rod 54 is moved backward in the manner described above and when the cam 50 is at the reference position (when the insertion groove 108 and the keyhole portion 114 are at the position where they overlap) as shown in FIGS. 5A and 5B, the insertion member 104 is inserted through the insertion hole 102 of the cam housing portion 40b to engage with the engaging portion 100.

Next, as shown in FIGS. 6A and 6B, in a state where the shaft portion 116 is engaged with the engaging portion 100, the gripping portion 118 is gripped to rotate the insertion member 104. Thus, the arc-shaped surface 50c of the cam 50 of FIG. 3 is brought into abutment against the base surface 70d of the push rod 70 (the abutment portion 54a is separated from the abutment position 51). In this manner, in a state where the cartridge 48 has moved forward, in other words, in a state where the cam 50 has rotated from the reference position, the fixed position adjustment of the third cutting tool 46 attached to the cartridge 48 is performed.

Next, as shown in FIGS. 5A and 5B, by gripping the gripping portion 118 and rotating the insertion member 104, the cutout surface 50a of the cam 50 is brought into abutment against the base surface 70d of the push rod 70. Due to this, the cam 50 is positioned at the reference position and the restricting portion 120 in the insertion groove 108 overlaps the keyhole portion 114, and therefore the insertion member 104 can be extracted from the insertion hole 102.

Before or after the insertion member 104 is extracted from the insertion hole 102, the fixed position adjustments of the first cutting tool 42 and the second cutting tool 44 held by the cutting tool holding portion 40a may be performed as needed. Furthermore, the fixed position adjustments for the first cutting tool 42, the second cutting tool 44, and the third cutting tool 46 may be performed in any order.

After the insertion member 104 is extracted from the insertion hole 102, the machining tool 10 is mounted on the machining center (not shown) with the cutting tool holding portion 40a and the cam housing portion 40b in a fixed state, and the rod 54 is moved forward by the actuator as shown in FIG. 2. Due to this, the abutment portion 54a of the rod 54 can abut against the abutment position 51 of the cam 50. By performing the fixed position adjustment as described above, it is possible to perform the cutting described above with the machining tool 10 in which the cutting edges 42a, 44a, and 46a of the respective cutting tools are arranged with high precision at the prescribed positions in the cutting tool holding portion 40a.

Based on the above, the machining tool 10 according to the present embodiment includes the restricting mechanism 56 capable of adjusting the phase of the cam 50 such that the phase of the cam 50 becomes the reference position where the abutment position 51 of the cam 50 separated from the abutment portion 54a of the rod 54 faces the abutment portion 54a. As a result, it is possible to easily and efficiently avoid a situation where the abutment portion 54a of the rod 54 abuts against a location other than the abutment position 51 of the cam 50.

In the machining tool 10 according to the present embodiment described above, the restricting mechanism 56 includes: the cam shaft 96 that extends along the direction of the rotational axis of the cam 50 and is fixed to the cam 50 in a manner to be rotatable along with the cam 50; the engaging portion 100 provided on the cam shaft 96; the insertion hole 102 that is formed in the cam housing portion 40b and enables communication between the outside of the cam housing portion 40b and the engaging portion 100; and the insertion member 104 that can rotate along with the cam 50 by being inserted through the insertion hole 102 from outside the cam housing portion 40b to engage with the engaging portion 100, wherein the insertion hole 102 enables the insertion member 104 inserted through the insertion hole 102 to be extracted only when the cam 50 is at the reference position.

Furthermore, in the machining tool 10 according to the present embodiment described above, the insertion hole 102 includes: the axial hole 110 that extends along the direction of the rotational axis of the cam 50; the circumferential groove 112 that extends inside the cam housing portion 40b in a direction intersecting the axial hole 110; and the keyhole portion 114 enabling communication, in the direction of the rotational axis of the cam 50, between only a portion of the circumferential groove 112 and the outside of the cam housing portion 40b. The insertion member 104 includes the shaft portion 116 that is inserted through the axial hole 110 to engage with the engaging portion 100, and the restricting portion 120 that protrudes from the shaft portion 116. The restricting portion 120 is capable of moving inside the circumferential groove 112 in accordance with the rotation of the cam 50 in a state where the shaft portion 116 is engaged with the engaging portion 100, and is capable of moving to the outside of the circumferential groove 112 through the keyhole portion 114 only when the cam 50 is at the reference position.

In the above cases, after the fixed position adjustment of a cutting tool is finished as described above, in order to extract the insertion member 104 from the insertion hole 102, it is necessary to rotate the insertion member 104 such that the phase of the cam 50 becomes the reference position. In other words, while the insertion member 104 is inserted through the insertion hole 102 and cannot be extracted, it can be determined that the phase of the cam 50 is different from the reference position. Therefore, by performing the simple operation of extracting the insertion member 104 from the insertion hole 102 before moving the rod 54 forward to bring the abutment portion 54a toward the cam 50, it is possible to easily and efficiently avoid a situation where the abutment portion 54a of the rod 54 abuts against a location other than the abutment position 51 of the cam 50. The timing at which the cam 50 is rotated using the insertion member 104 is not limited to when the fixed position adjustment is performed, and can be any timing as needed.

In the machining tool 10 according to the present embodiment described above, the cam 50 includes the arc-shaped surface 50c following an arc-shaped outer periphery thereof, and the cutout surface 50a obtained by cutting away a portion of the arc, and by rotating with the center of the arc as the rotational center, the cam 50 can selectively bring the arc-shaped surface 50c and the cutout surface 50a into abutment against the base surface 70d of the cartridge 48. The cartridge 48 moves forward when the arc-shaped surface 50c abuts against the base surface 70d, and the cartridge 48 moves backward when the cutout surface 50a abuts against the base surface 70d.

The machining tool 10 according to the present embodiment described above further includes the cartridge biasing member 52 that elastically biases the cartridge 48 in the backward direction. The cartridge 48 is moved forward against the elastic force of the cartridge biasing member 52 due to the arc-shaped surface 50c abutting against the base surface 70d, and the cartridge 48 is moved backward under the effect of the elastic bias of the cartridge biasing member 52 due to the cutout surface 50a abutting against the base surface 70d.

In these cases, as described above, the cartridge 48 can be moved back and forth by an amount corresponding to a difference between the radius r of the arc-shaped surface 50c and the length L of the perpendicular line from the center of the arc to the cutout surface 50a. In other words, by bringing the arc-shaped surface 50c that follows the outer periphery of the arc into abutment against the base surface 70d of the cartridge 48, the cartridge 48 can be moved farther forward by the above difference than when the cutout surface 50a is brought into abutment against the base surface 70d.

At this time, since the cam 50 rotates with the center of the arc as the rotational center, the forward movement amount of the cartridge 48 can be made equal no matter what portion of the arc-shaped surface 50c is abutted against by the base surface 70d. Accordingly, it is possible to easily maintain the positioning precision of the cutting tools via the cartridge 48 without the need for a high-precision adjustment of the rotational amount of the cam 50. Furthermore, since the cutting with the cutting tool attached to the cartridge 48 is performed in a state where the arc-shaped surface 50c with an arc shape following the outer periphery of the arc abuts against the base surface 70d of the cartridge 48, it is possible to improve the durability of the machining tool 10 with respect to the machining reaction force.

In the machining tool 10 according to the present embodiment described above, the abutment portion 54a protrudes from the outer peripheral surface of the rod 54; the abutment position 51 is provided on the inner surface of the recessed portion 50b into which the abutment portion 54a is insertable; the arc-shaped surface 50c is arranged between the recessed portion 50b and the cutout surface 50a in the circumferential direction of the arc; and by moving forward toward the tip side of the tool body 40 while the abutment portion 54a is brought into abutment against the abutment position 51, the rod 54 causes the cam 50 to rotate such that the arc-shaped surface 50c abuts against the base surface 70d, and by moving backward toward the base side of the tool body 40 while the abutment portion 54a is brought into abutment against the abutment position 51, the rod 54 causes the cam 50 to rotate such that the cutout surface 50a abuts against the base surface 70d.

As described above, the forward movement amount of the cartridge 48 can be made equal no matter what portion of the arc-shaped surface 50c is abutted against by the base surface 70d, and so it is possible to easily maintain the positioning precision of the cutting tools via the cartridge 48 with a simple configuration without the need for a high-precision adjustment of the back and forth movement amount of the rod 54.

The present invention is not limited to the above-described embodiment, and it goes without saying that various modifications could be adopted therein without departing from the essence and gist of the present invention.

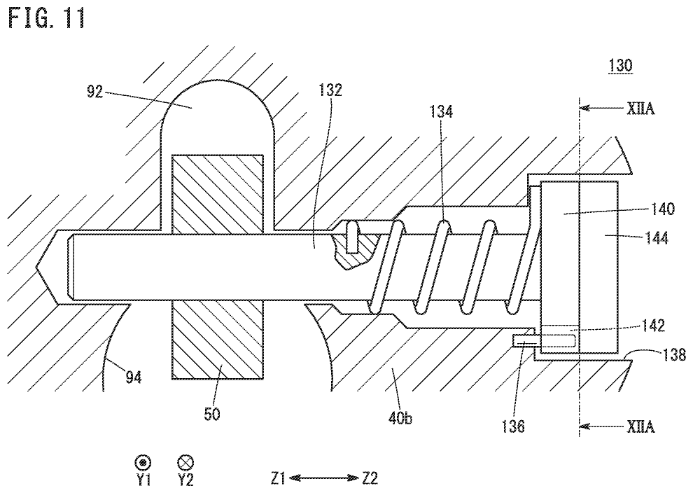

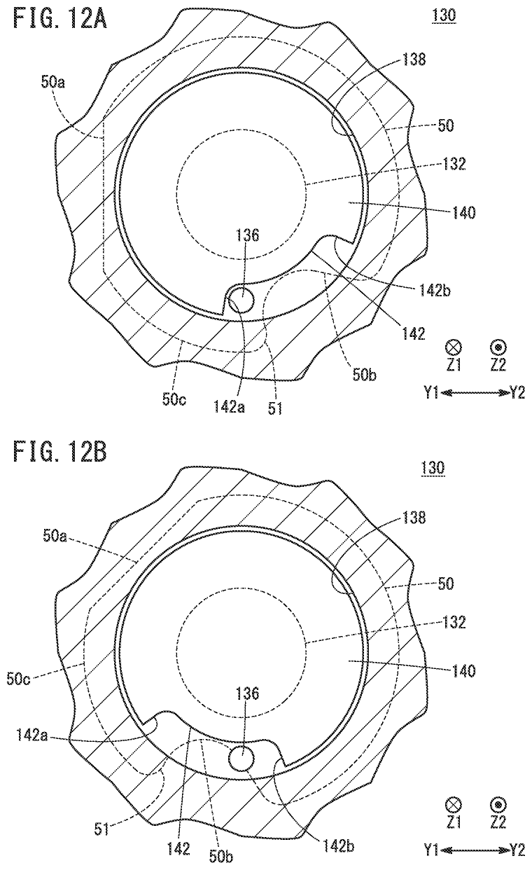

For example, the machining tool 10 may include a restricting mechanism 130 shown in FIGS. 11 to 12B, instead of the restricting mechanism 56 shown in FIGS. 5A to 6B. The restricting mechanism 130 includes a cam shaft 132, a cam biasing member 134, and a stopper 136. Each constituent component of the restricting mechanism 130 is installed in an insertion hole 138 formed in the cam housing portion 40b of FIG. 11 along the direction of the rotational axis of the cam 50.

As shown in FIG. 11, the cam shaft 132 extends along the direction of the rotational axis of the cam 50 (arrow Z1 and Z2 directions), and is fixed to the cam 50 in a manner to be rotatable along with the cam 50. One end portion of the cam shaft 132 in the extension direction (end portion on the arrow Z1 side) is rotatably fixed to the inner wall of the cam chamber 92. The other end portion of the cam shaft 132 in the extension direction (end portion on the arrow Z2 side) is provided with a flange portion 140.

As shown in FIGS. 12A and 12B, the flange portion 140 is provided with a cutout portion 142, which is obtained by cutting away a portion of the flange portion 140 in the circumferential direction thereof toward the center of the flange portion 140 in the radial direction. Furthermore, as shown in FIG. 11, an end of the flange portion 140 on the other end side in the direction of the rotational axis of the cam 50 (arrow Z2 side) is covered by a cover member 144. In FIGS. 12A and 12B, the cover member 144 and the cam biasing member 134 are omitted from the drawings.

As shown in FIG. 11, the cam biasing member 134 is formed from a torsion coil spring or the like, for example, and elastically biases the cam 50 in the rotational direction via the cam shaft 132. The stopper 136 restricts the cam 50 that is elastically biased by the cam biasing member 134 via the cam shaft 132 from rotating beyond the reference position. In the present embodiment, the stopper 136 is formed from a pin that extends along the direction of the rotational axis of the cam 50.

One end of the stopper 136 (end portion on the arrow Z1 side) is fixed to a wall portion forming the insertion hole 138 of the cam housing portion 40b. The other end of the stopper 136 is disposed inside the cutout portion 142 of the flange portion 140. As shown in FIG. 12A, by abutting against an inner wall 142a on one end side of the cutout portion 142 in the circumferential direction, the stopper 136 can restrict the cam 50 from rotating beyond the reference position in the direction of the elastic bias of the cam biasing member 134. In the present embodiment, when the cam 50 is at the reference position, the stopper 136 and the inner wall 142a of the cutout portion 142 are arranged slightly separated from each other.

Furthermore, the length of the cutout portion 142 in the circumferential direction is set such that, even in a case where, as shown in FIG. 12B, the cam 50 is oriented such that the arc-shaped surface 50c thereof abuts against the base surface 70d of the cartridge 48 of FIG. 3, for example, the stopper 136 does not abut against an inner wall surface 142b on the other end side of the cutout portion 142 in the circumferential direction. Furthermore, the elastic bias force of the cam biasing member 134 is set to a magnitude that does not impede the back and forth movement of the rod 54 whose abutment portion 54a shown in FIG. 2 abuts against the abutment position 51. Therefore, even when the stopper 136 and the cam biasing member 134 are provided as described above, restriction of the rotation of the cam 50 for moving the cartridge 48 back and forth is avoided.

The restricting mechanism 130 such as described above can be favorably applied to a machining tool 10 in which, for example, the cam housing portion 40b forms one spindle of a multi-spindle machining head (gang head) having a plurality of machining spindles (none of which are shown in the drawings). With this type of machining tool 10, when a cutting tool held by the cutting tool holding portion 40a is worn down or the like, the cutting tool holding portion 40a is removed from the cam housing portion 40b in a state where the rod 54 has moved backward, as shown in FIG. 4.

As a result, the cam 50 contacts neither the cartridge 48 nor the abutment portion 54a of the rod 54, and is therefore released from a state of having its rotation restricted by the contact with the cartridge 48 or the abutment portion 54a. In such a case, the cam 50 is kept in a state of being approximately at the reference position by the elastic bias force from the cam biasing member 134 via the cam shaft 132, and the restriction applied from the stopper 136.

Accordingly, when, after replacement or the like of the worn cutting tool has been performed, the cutting tool holding portion 40a is again attached to the cam housing portion 40b and the abutment portion 54a of the rod 54 is brought near the cam 50, the abutment position 51 of the cam 50 is in a state of facing the abutment portion 54a of the rod 54. As a result, it is possible to easily and efficiently avoid a situation where the abutment portion 54a of the rod 54 abuts against a location other than the abutment position 51 of the cam 50.

In the embodiment described above, the plurality of cutting tools included in the machining tool 10 are three cutting tools, namely, the first cutting tool 42, the second cutting tool 44, and the third cutting tool 46, but the number of cutting tools is not particularly limited to this. The number of cutting tools may be set according to the number of inclined surfaces to be formed on the inner periphery of the opening, and may be two or may be four or more.

### LIST OF REFERENCE NUMERALS

10: machining tool
40: tool body
40a: cutting tool holding portion
40b: cam housing portion
48: cartridge
50: cam
50a: cutout surface
50b: recessed portion
50c: arc-shaped surface
51: abutment position
54: rod
54a: abutment portion
56, 130: restricting mechanism
96, 132: cam shaft
100: engaging portion
102: insertion hole
104: insertion member
106: concave portion
106a: peripheral wall
108: insertion groove
110: axial hole
112: circumferential groove
114: keyhole portion
116: shaft portion
120: restricting portion
134: cam biasing member
136: stopper
138: insertion hole
140: flange portion
142: cutout portion
142a: inner wall

What is claim is:

1. A machining tool that cuts an inner periphery of a workpiece including an opening to form a plurality of machined surfaces, the machining tool comprising:
a tool body that includes a cam housing portion and a cutting tool holding portion fixed in an attachable/detachable manner to a tip side of the cam housing portion, and is rotationally driven around an axial line;
a plurality of cutting tools held by the cutting tool holding portion and configured to rotate along with the tool body;
a cartridge which is provided to the cutting tool holding portion in a manner to be movable back and forth, and to which at least one of the plurality of cutting tools is attached;
a cam housed inside the cam housing portion and configured to move the cartridge back and forth by abutting against the cartridge and rotating;
a rod configured to move back and forth along the axial line inside the tool body;
an abutment portion provided on the rod and configured to cause the cam to rotate by abutting against an abutment position of the cam according to back and forth movement of the rod; and
a restricting mechanism configured to adjust a phase of the cam in a state where the abutment portion is separated from the abutment position, in a manner so that the phase of the cam becomes a reference position where the abutment position faces the abutment portion.

2. The machining tool according to claim 1, wherein
the restricting mechanism includes:
a cam shaft that extends along a direction of a rotational axis of the cam and is fixed to the cam in a manner to be rotatable along with the cam;
an engaging portion provided to the cam shaft;
an insertion hole that is formed in the cam housing portion and enables communication between an outside of the cam housing portion and the engaging portion; and
an insertion member that is rotatable along with the cam by being inserted through the insertion hole from the outside of the cam housing portion to engage with the engaging portion, and wherein
the insertion hole allows the insertion member that is inserted through the insertion hole to be extracted only when the cam is at the reference position.

3. The machining tool according to claim 2, wherein
the insertion hole includes:
an axial hole that extends along the direction of the rotational axis of the cam;
a circumferential groove that extends inside the cam housing portion in a direction intersecting the axial hole; and
a keyhole portion that enables communication, in the direction of the rotational axis of the cam, between only a portion of the circumferential groove and the outside of the cam housing portion, and wherein
the insertion member includes a shaft portion that is inserted through the axial hole to engage with the engaging portion, and a restricting portion that protrudes in a radial direction from the shaft portion, and
the restricting portion is configured to move inside the circumferential groove in accordance with rotation of the cam in a state where the shaft portion is engaged with the engaging portion, and is configured to move to an outside of the circumferential groove through the keyhole portion only when the cam is at the reference position.

4. The machining tool according to claim 1, wherein the restricting mechanism includes:
a cam shaft that extends along a direction of a rotational axis of the cam and is fixed to the cam in a manner to be rotatable along with the cam;
a cam biasing member configured to elastically bias the cam, via the cam shaft, in a rotational direction toward the reference position; and
a stopper configured to restrict the cam that is elastically biased by the cam biasing member via the cam shaft from rotating beyond the reference position.

5. The machining tool according to claim 4, wherein
the cam shaft includes a flange portion,
the flange portion is provided with a cutout portion having a shape obtained by cutting away a portion of the flange portion in a circumferential direction toward a center of the flange portion in a radial direction,
the stopper extends along the direction of the rotational axis of the cam, one end of the stopper is fixed to the cam housing portion, and another end of the stopper is disposed inside the cutout portion, and
the stopper restricts rotation of the cam beyond the reference position by abutting against an inner wall of the cutout portion.

6. The machining tool according to claim 1, wherein
the cam includes an arc-shaped surface that follows an outer periphery of an arc, and a cutout surface formed by cutting away a portion of the arc, the cam being configured to selectively bring the arc-shaped surface and the cutout surface into abutment against a base surface of the cartridge by rotating with a center of the arc as a rotational center,
the cartridge moves forward when the arc-shaped surface abuts against the base surface, and
the cartridge moves backward when the cutout surface abuts against the base surface.

7. The machining tool according to claim 6, further comprising
a cartridge biasing member configured to elastically bias the cartridge in a backward direction, wherein
the cartridge is moved forward against an elastic force of the cartridge biasing member due to the arc-shaped surface abutting against the base surface, and
the cartridge is moved backward under an effect of elastic bias of the cartridge biasing member due to the cutout surface abutting against the base surface.

8. The machining tool according to claim 6, wherein
the abutment portion protrudes from an outer peripheral surface of the rod,
the abutment position is provided on an inner surface of a recessed portion into which the abutment portion is insertable,
the arc-shaped surface is arranged between the cutout surface and the recessed portion in a circumferential direction of the arc, and
by moving forward toward a tip side of the tool body while the abutment portion is brought into abutment against the abutment position, the rod causes the cam to rotate in a manner so that the arc-shaped surface abuts against the base surface, and by moving backward toward a base side of the tool body while the abutment portion is brought into abutment against the abutment position, the rod causes the cam to rotate in a manner so that the cutout surface abuts against the base surface.
